(19) United States
(12) Patent Application Publication
(10) Pub. No.: US 2010/0134500 A1
(43) Pub. Date: Jun. 3, 2010

(54) APPARATUS AND METHOD FOR PRODUCING CROWD ANIMATION

(75) Inventor: Sung June CHANG, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/490,028

(22) Filed: Jun. 23, 2009

(30) Foreign Application Priority Data
Dec. 2, 2008 (KR) 10-2008-0121020
Mar. 12, 2009 (KR) 10-2009-0021064

(51) Int. Cl. G06T 15/70

(52) U.S. Cl. 345/474

(57) ABSTRACT

An apparatus for producing crowd animation includes: a user-input controller for receiving from a user level of detail (LOD) of each individual in a picture of the crowd animation; a simulation controller for performing simulation of the crowd animation for a specific time period to update simulation information on each individual; and a display controller for displaying the picture of the crowd animation by using display information corresponding to the LOD of each individual, the display information being selected among the simulation information. The LOD of each individual indicates: displaying the individual with location information thereof only; displaying the individual with the location and model information thereof; or displaying the individual with the location, model and motion information thereof. The simulation information includes location information, model information and motion information of each individual.

### CROSS-REFERENCE(S) TO RELATED APPLICATION

The present invention claims priority of Korean Patent Application No. 10-2008-0121020, filed on Dec. 2, 2008, and Korean Patent Application No. 10-2009-0021064, filed on Mar. 12, 2009, which are incorporated herein by reference.

### FIELD OF THE INVENTION

The present invention relates to an apparatus and method for producing crowd animation; and, more particularly, to an apparatus and method for efficiently producing large-scale crowd animation in massive crowd simulation using interactive LOD (Level of Detail) control techniques, the apparatus and method displaying detailed animation and model of a selected individual in a crowd while also displaying overall feature of the entire crowd.

### BACKGROUND OF THE INVENTION

In conventional crowd animation producing methods, in order to simulate a massive crowd under limited system resource, each individual is firstly modeled in a simplest manner and based thereon detailed motion and model are added to each individual.

In alternative methods, each individual is originally modeled in various detail levels to produce a crowd in a virtual world by automatically choosing models having high detail levels for individuals near to a camera view while choosing models having low detail levels for individuals far from the camera view.

However, since the detailed motion and model of each individual cannot be displayed until complete the simulation, the former methods have a drawback in that the detailed motion and model do not match with the completed simulation.

As for the latter methods, it is difficult to produce large-scale crowd animation because system resource is consumed by applying real motions also to simplified levels. Further, it is difficult for a user to interactively produce crowd animation by selecting LOD of each individual as needed, because the LOD is selected automatically.

### SUMMARY OF THE INVENTION

In view of the above, the present invention provides an apparatus and method for producing crowd animation for efficiently producing large-scale crowd animation in massive crowd simulation using interactive LOD control techniques, the apparatus and method displaying detailed animation and model of a selected individual in a crowd while also displaying flow of the entire crowd.

In accordance with a first aspect of the present invention, there is provided an apparatus for producing crowd animation including:

a user-input controller for receiving from a user level of detail (LOD) of each individual in a picture of the crowd animation;

a simulation controller for performing simulation of the crowd animation for a specific time period to update simulation information on each individual; and

a display controller for displaying the picture of the crowd animation by using display information corresponding to the LOD of each individual, the display information being selected among the simulation information.

The apparatus may further include a user-input storage for storing therein the LOD information received from the user.

Preferably, the LOD of each individual indicates one of: displaying the individual with location information thereof only; displaying the individual with the location and model information thereof; and displaying the individual with the location, model and motion information thereof.

The apparatus may further include a simulation storage for storing therein the updated simulation information.

Preferably, the simulation controller performs the simulation whenever receiving an update request from the user.

Preferably, the simulation information includes location information, model information and motion information of each individual.

The apparatus may further include a display storage for storing therein the display information.

Preferably, each individual is a group of people or objects in the picture of the crowd animation.

In accordance a second aspect of the present invention, there is provided a method for producing crowd animation including:

receiving from a user level of detail (LOD) of each individual in a picture of the crowd animation;

performing simulation of the crowd animation for a specific time period to update simulation information on each individual; and

selecting, among the simulation information, display information corresponding to the LOD of each individual;

displaying the picture of the crowd animation by using the display information.

Preferably, the LOD of each individual indicates one of: displaying the individual with location information thereof only; displaying the individual with the location and model information thereof; and displaying the individual with the location, model and motion information thereof.

Preferably, the simulation is performed whenever receiving an update request from the user.

Preferably, the simulation information includes location information, model information and motion information of each individual.

Preferably, each individual is a group of people or objects in the picture of the crowd animation.

In accordance with a third aspect of the present invention, there is provided a storage media storing therein a computer-readable program to execute on a computer the method of the second aspect of the present invention.

According to the present invention, simulation of the crowd animation is performed to update simulation information on each individual, and among the updated simulation information, information on each individual corresponding to the LOD thereof is used to display a picture of the crowd animation. Thus, individuals in the same picture can be represented in different LOD, and further, detailed motion of individuals near to a camera view or selected by a user can be displayed while overall feature of the entire crowd is displayed, which results in more efficient display of the crow animation.

### BRIEF DESCRIPTION OF THE DRAWINGS

The above features of the present invention will become apparent from the following description of embodiments, given in conjunction with the accompanying drawings, in which:

FIG. 1 illustrates a block diagram of an apparatus for producing crowd animation in accordance with an embodiment of the present invention; and

FIG. 2 illustrates a flowchart of an LOD realization procedure performed in the apparatus of FIG. 1.

### DETAILED DESCRIPTION OF THE EMBODIMENTS

Hereinafter, embodiments of the present invention will be described in detail with reference to the accompanying drawings, which form a part hereof.

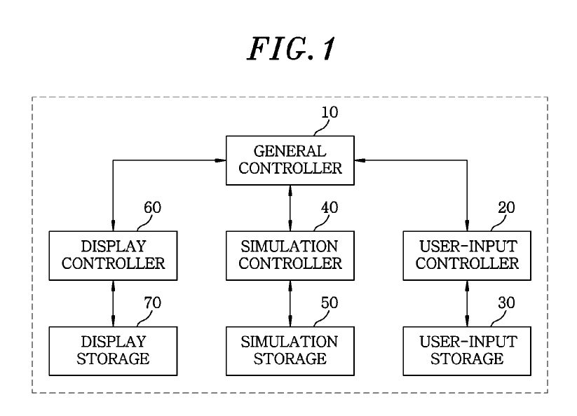

FIG. 1 illustrates a block diagram of an apparatus for producing crowd animation in accordance with the present invention, which allows LOD (Level of Detail) description of each individual. The apparatus includes: a general controller 10, a user-input controller 20, a user-input storage 30, a simulation controller 40, a simulation storage 50, a display controller 60 and a display storage 70.

The general controller 10 controls operation of the user-input controller 20, the simulation controller 40 and the display controller 60 to thereby control overall operation of producing crowd animation.

The user-input controller 20 receives from a user LOD of each individual forming the crowd animation. The user-input storage 30 stores therein the LOD received from the user via the user-input controller 20.

Here, each individual of the crowd animation indicates a person, an object or a group of people or objects in a picture of the crowd animation.

The LOD means a detail level of describing each individual in the picture of the crowd animation. For example, LOD of an individual include a location level representing a location of the individual only, a model level representing also a size and shape of the individual and a motion level representing the location, size, shape and motion of the individual.

The simulation controller 40 performs, for a specific time period, simulation of the crowd animation to update simulation information on each individual. The simulation information of each individual includes, e.g., a location, model and motion of each individual. After the simulation controller 40 performs the simulation update, the simulation storage 50 stores therein updated simulation information on the crowd animation.

The display controller 60 retrieves, among the updated simulation information stored in the simulation storage 50, simulation information on each individual corresponding to the LOD thereof, and stores the retrieved simulation information in the display storage 70. The display controller 60 displays a picture of the crowd animation based on the simulation information stored in the display storage 70. The display storage 70 stores therein the simulation information on each individual retrieved by the display controller 60.

That is, in accordance with the apparatus of the present invention, the user-input controller 20 receives as a user-input LOD of each individual and stores the LOD in the user-input storage 30. The simulation controller 40 simulates the crowd animation and stores as simulation result the simulation information in the simulation storage 50.

By using the LOD of each individual stored in the user-input storage 30, the display controller 60 retrieves necessary simulation information corresponding to the LOD of each individual from the simulation storage 50, stores the retrieved simulation information in the display storage 70 and displays the picture of the crowd animation on a screen.

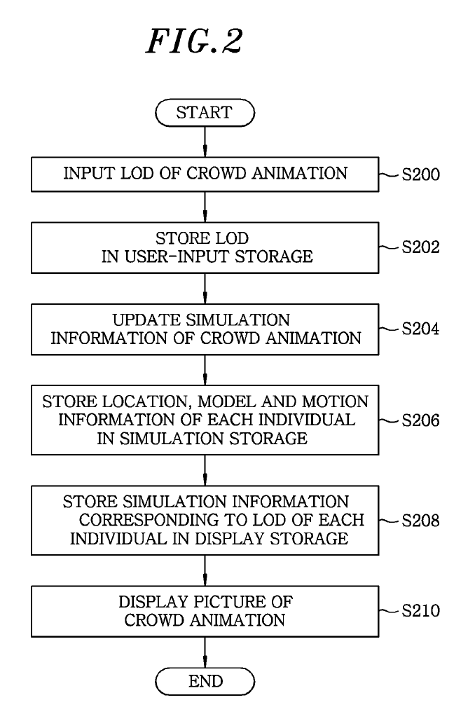

FIG. 2 illustrates a flowchart of an LOD realization procedure performed in the apparatus of FIG. 1.

First, the user-input controller 20 receives from a user LOD of each individual forming crowd animation (step S200). Subsequently, the user-input controller 20 stores the LOD received from the user in the user-input storage 30 (step S202).

The simulation controller 40 performs simulation of the crowd animation for a specific time period to update simulation information on each individual (step S204). Through the simulation, the simulation information, e.g., location, model and motion information, on each individual is newly updated. The simulation controller 40 stores the updated simulation information in the simulation storage 50 (step S206).

The display controller 60 retrieves the LOD of each individual stored in the user-input storage 30 and retrieves from the simulation storage 50 the simulation information on each individual corresponding to the LOD thereof to store the retrieved simulation information on each individual in the display storage 70 (step S208).

In the step S208, if LOD of an individual is low, the display controller 60 retrieves from the simulation storage 50 basic information, e.g., the location information, on the individual only. When more detailed information is necessary, model information or the like on the individual is also retrieved from the simulation storage 50. If LOD of an individual is very high, all of the simulation information, e.g., location, model and motion information, on the individual are retrieved from the simulation storage 50.

After storing the simulation information on each individual corresponding to the LOD thereof, the display controller 60 displays the picture of the crowd animation, in which each individual is represented according to the LOD thereof, by using the simulation information stored in the display storage 70 (step S210).

While the invention has been shown and described with respect to the embodiments, it will be understood by those skilled in the art that various changes and modification may be made without departing from the scope of the invention as defined in the following claims.

What is claimed is:

1. An apparatus for producing crowd animation comprising:
a user-input controller for receiving from a user level of detail (LOD) of each individual in a picture of the crowd animation;
a simulation controller for performing simulation of the crowd animation for a specific time period to update simulation information on each individual; and
a display controller for displaying the picture of the crowd animation by using display information corresponding to the LOD of each individual, the display information being selected among the simulation information.

2. The apparatus of claim 1, further comprising a user-input storage for storing therein the LOD information received from the user.

3. The apparatus of claim 1, wherein the LOD of each individual indicates one of: displaying the individual with location information thereof only; displaying the individual with the location and model information thereof; and displaying the individual with the location, model and motion information thereof.

4. The apparatus of claim 1, further comprising a simulation storage for storing therein the updated simulation information.

5. The apparatus of claim 1, wherein the simulation controller performs the simulation whenever receiving an update request from the user.

6. The apparatus of claim 1, wherein the simulation information includes location information, model information and motion information of each individual.

7. The apparatus of claim 1, further comprising a display storage for storing therein the display information.

8. The apparatus of claim 1, wherein each individual is a group of people or objects in the picture of the crowd animation.

9. A method for producing crowd animation comprising:
receiving from a user level of detail (LOD) of each individual in a picture of the crowd animation;
performing simulation of the crowd animation for a specific time period to update simulation information on each individual; and
selecting, among the simulation information, display information corresponding to the LOD of each individual;
displaying the picture of the crowd animation by using the display information.

10. The method of claim 9, wherein the LOD of each individual indicates one of: displaying the individual with location information thereof only; displaying the individual with the location and model information thereof; and displaying the individual with the location, model and motion information thereof.

11. The method of claim 9, wherein the simulation is performed whenever receiving an update request from the user.

12. The method of claim 9, wherein the simulation information includes location information, model information and motion information of each individual.

13. The method of claim 9, wherein each individual is a group of people or objects in the picture of the crowd animation.

14. A storage media storing therein a computer-readable program to execute on a computer the method of claim 9.
